(19) United States
(12) Patent Application Publication
(10) Pub. No.: US 2015/0142859 A1
(43) Pub. Date: May 21, 2015

(54) DOCUMENT COLLECTIONS DISTRIBUTION AND PUBLISHING

(71) Applicant: Microsoft Corporation, Redmond, WA (US)

(72) Inventors: ANDREW C. HAON, SEATTLE, WA (US); SOHAIL TARIQ, REDMOND, WA (US); ROU-PENG HUANG, WOODINVILLE, WA (US); LUCIANA SILVA DANTAS, SAMMAMISH, WA (US); LAUREN ELIZABETH ANN JAVOR, SEATTLE, WA (US); DANIEL J. RONEY, SEATTLE, WA (US); RAMKUMAR KRISHNAN, REDMOND, WA (US); MARK ALLAN HOPWOOD, KIRKLAND, WA (US); ULZIIDELGER LOBO, SAMMAMISH, WA (US)

(73) Assignee: Microsoft Corporation, Redmond, WA (US)

(21) Appl. No.: 14/082,740

(22) Filed: Nov. 18, 2013

(51) Int. Cl. G06F 17/30

(52) U.S. Cl. CPC G06F 17/30091
USPC 707/812

(57) ABSTRACT

The publishing and distribution of productivity documents to collections are described. Document collections distribution and publishing can be facilitated by a service that receives documents to publish and stores the documents at a storage of the service. The documents can be stored in the file formats they were created in, including productivity application file formats such as word processing file format and presentation file format. The service also stores metadata associated with each document, including a collection identifier that identifies each collection that a document is added to. The documents and the collections to which the documents may be associated with are searchable and discoverable through the service.

### BACKGROUND

Users create millions of documents using productivity applications such as the MICROSOFT OFFICE suite of applications from Microsoft Corp., including MICROSOFT WORD, MICROSOFT EXCEL, MICROSOFT POWERPOINT, all registered trademarks of Microsoft Corp.; the APACHE OPENOFFICE available from the Apache Software Foundation; the LIBREOFFICE suite of applications available from THE DOCUMENT FOUNDATION, registered trademarks of The Document Foundation; and the APPLE iWORK suite of applications from Apple Inc, including APPLE PAGES, APPLE KEYNOTE, and APPLE NUMBERS, all registered trademarks of Apple Inc. However, there is no easy way today to publish these productivity application file types.

Generally, published content is either created in a file format suitable for publication or converted to hypertext markup language (HTML) file format so that the content is easily searchable and distributable over the Web. Accordingly, it would be beneficial to have a way to make documents that were created using a productivity application available for a wider community.

### BRIEF SUMMARY

The publishing and distribution of productivity documents to collections are described. According to certain implementations, a publishing service is presented that facilitates document collections and distribution.

A document in a productivity application file format can be published via the publishing service. For example, in response to the publishing service receiving the document and a command to publish the document, the document can be stored by the service along with metadata providing document properties to maintain attribution and manage collections to which the document may be added.

A published document becomes publicly available and discoverable through the service, which also enables multiple users to include the document in their own collections of documents. The metadata for the document is updated with a user collection identifier so that the collections that the document is part of can be managed by the service while the document remains attributed to the author. Representative images can be generated to facilitate browsing of documents and collections.

The documents do not require conversion from the productivity application file format. Instead, metadata is associated with the documents to facilitate classification and search; and productivity reader application components may be incorporated to facilitate viewing of the productivity application file formats

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an operating environment in which document collections distribution and publishing may be carried out.

FIG. 2 illustrates a method of facilitating document collections distribution and publishing.

FIG. 3 illustrates an example publish process flow.

FIGS. 4A-4C are views illustrating an example publish process flow.

FIG. 5 illustrates a process flow in which metadata for a document that is being published can be entered before or during the uploading of a file to the service.

FIG. 6 is a view of an example interface.

FIG. 7 illustrates an example search interface.

FIG. 8 shows a block diagram illustrating example details of a publish and collection server that may be used to implement publish and collection services.

### DETAILED DESCRIPTION

The publishing and distribution of productivity documents to collections are described. According to certain implementations, a publishing service is presented that facilitates document collections and distribution.

A service is described in which documents of any format, including MICROSOFT OFFICE productivity application file type formats, can be published and provided on a distribution network. Embodiments enable the sharing (distribution and publishing) of documents that are in an Office Open Extensible Markup Language (XML) file format (.docx, .pptx, .xlsx), MICROSOFT WORD document file format (.doc) or other word processing document file format, MICROSOFT EXCEL binary file format (.xls) or other spreadsheet file format, MICROSOFT POWERPOINT presentation file format (.ppt) or other presentation file format.

Unlike some web publishing services, the format of the document does not have to be converted to a hypertext markup language format. Rather, the document can remain in the format in which it was created.

By being published via the service, the document—as well as collections of documents—can be discoverable, read and otherwise available to the public for consumption.

Document publishing refers to the storage of user's content for access by others that may be interested in the content. Distribution networks can provide a platform for document publishing. In some implementations, the distribution network can include a hosted site through which users may access the features of the publication and collection services.

Collections refer to user-created content lists on the distribution network. A collection can be similar to a playlist, but instead of a grouping of music, a collection provides a way to group documents. A collection can include documents the user published on the network as well as documents that others publish. A collection can be used to organize and collect documents (both her own and others) that the user is interested in. A user may create a new collection, organize an existing collection, and add (related) documents (both published by the user or by others on the distribution network) to a new or existing collection.

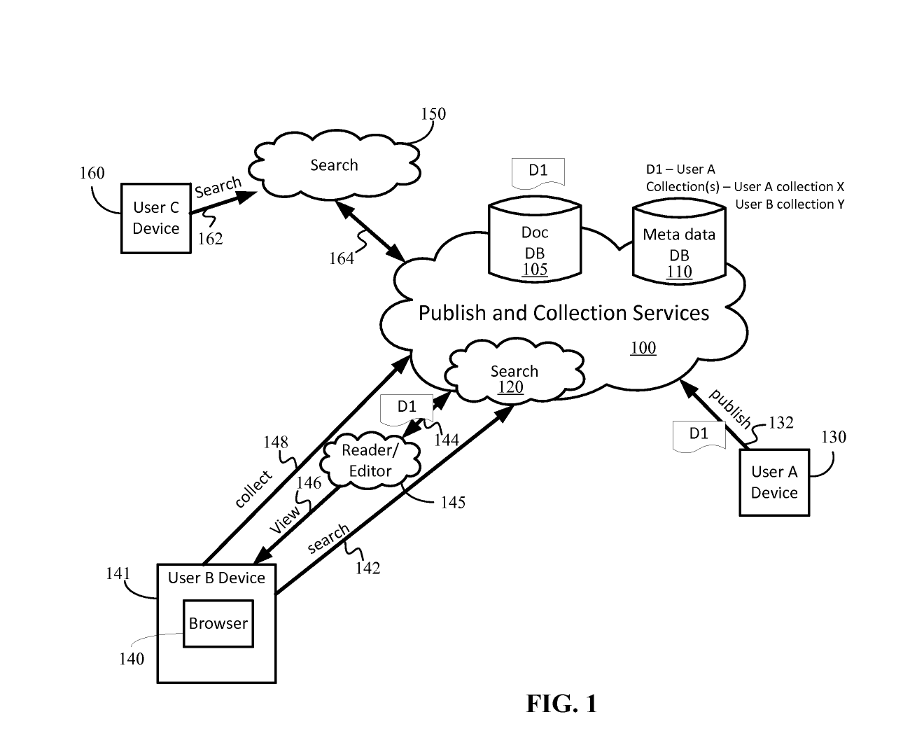

FIG. 1 illustrates an operating environment in which document collections distribution and publishing may be carried out. According to an embodiment, a service such as publish and collection service(s) 100 may be used to implement document collections distribution and publishing.

Publish and collection service(s) 100 can include and/or manage a documents database 105 and a metadata database 110. The documents database 105 and metadata database 110 may be one or more databases managed or used by the publish and collection service(s) 100. The databases may be in a distributed environment or may be stored in one or more storage devices at a single location. In addition, although the documents database 105 and metadata database 110 are shown as separate databases, a single database may be used in some implementations.

The publish and collection service(s) 100 can include built-in search functionality or utilize a search service 120 for facilitating a search of the stored documents and/or collections of documents.

For publishing a document, the publish and collection service(s) 100 can receive a document D1 via a suitable portal from a User A device 130. For example, the document D1 may be received via a productivity application communicating with the publish and collection service(s) 100 or via a user interface rendered in a browser running on the User A device 130.

User A device 130 (or any user's device that accesses or communicates with the service) may be a computing device such as, but not limited to, a laptop computer, a desktop computer, a tablet, a smart phone, a personal digital assistant, a smart television, a gaming console and the like. A user may interact with the user interface via voice, touch, pointer device (e.g., mouse), non-contact gestures, and keyboard/keypad as examples.

When a document and a request to publish 132 is received by the service 100, the document D1 can be stored in the document database 105 and metadata associated with the document D1 can be stored in the metadata database 110. During the publishing process, the document can be published to a specified collection.

The service 100 can manage the collections by a suitable identifier stored in the metadata database 110. For example, the document D1 can include metadata indicating the author of the document as user A and collection information indicating user A has added the document D1 to collection X.

Once in the collection, the document may be accessed via the collection or as an individual document by the publisher (e.g., user A) and by others (e.g., user B and user C).

For example, a second user, user B, may access the publish and collection service(s) 100 from a browser application 140 running on User B device 141 (e.g., a computing device such as a tablet, laptop, smartphone, desktop, and the like). User B may conduct a search 142 of the documents or collections available through the distribution network of the publish and collection service(s) 100. Documents (or collections) resulting from the search can be viewed and even added to a user's own collections.

The service (e.g. publish and collection service(s) 100) can make the published content available for viewing in a reader 145. The service can include or incorporate a web application component (WAC), for example in the form of an Office Web Application, that enables a user to at least view a document (e.g., in word processing document format, presentation document format, and spreadsheet document format), in a browser (e.g., browser application 140). Other reader applications or services may be used as well. In addition, editing features (such as highlighting or commenting) may optionally be available.

As an example scenario, user B may access the distribution network of the publish and collection service(s) 100 and conduct a search 142. The document D1 may be included in the results of the search 142 and, in response to an indication that user B would like to view the document D1, the reader 145 can access the document D1 (144) and provide a view 146 of the document D1 to the user B.

The user B may decide to add the document D1 to their collection (or create a new collection with document D1). Accordingly, in response to receiving an indication that the document D1 is being added to a collection of user B (148), the publish and collection service(s) 100 can update the metadata in the metadata database 110, for example by adding an entry for document D1 of user B collection Y. The metadata for the document D1 would now include a collection indicator of collection X for user A and collection Y for user B. Both collections can be discoverable (so long as they are public).

Instead of, or in addition to, searching for documents and collections directly from a website portal of the publish and collection service(s) 100, the documents stored in the documents database can be discoverable through a more traditional search engine search 150. For example, another user (e.g., user C) at User C device 160 may conduct a query 162 via a search engine 150, which can crawl or otherwise communicate 164 with the sources available through the publish and collection service(s) 100 to generate search results that include the published documents available through the publish and collection service(s) 100.

Embodiments of the service enable documents to be added to not only the author's collections, but also to other people's collections while remaining attributed to the original author and/or publisher. In this manner, a user's collection can include their own published content and content published by others where the content published by others maintains attribution of authorship.

Other users of the service can add the document to their collections and the service keeps track of the collections referencing the document by using metadata that is managed by the service. The metadata includes author (or publisher) and the collections to which the document is associated. In this manner, a single document is stored even though the document can be identified in and be considered to be part of multiple users' collections. Also—the author attribute is maintained (because authorship/publisher is part of the metadata and not changeable even if many people add the document to their collection).

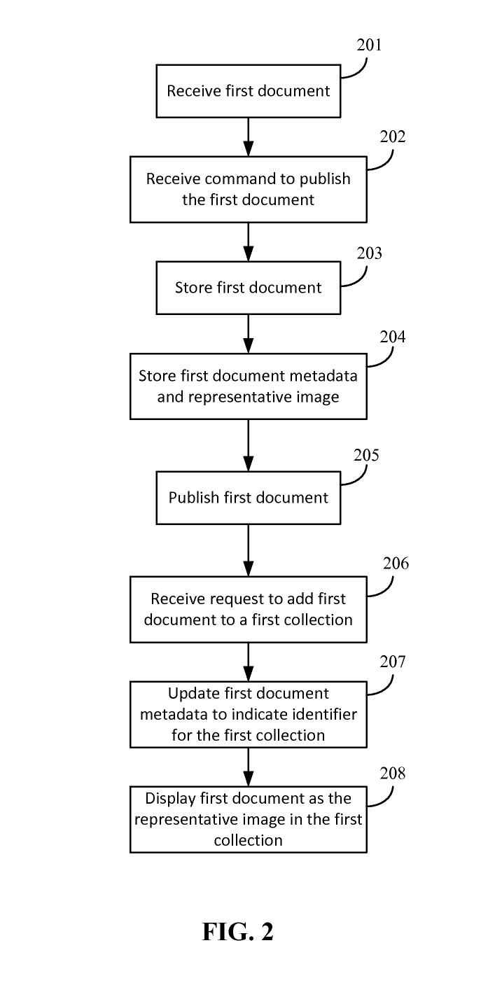

FIG. 2 illustrates a method of facilitating document collections distribution and publishing.

Referring to FIG. 2, a method of facilitating document collections distribution and publishing can include receiving a document to publish (201). The document may be received via a user interface rendered in a browser running on a user's device. Alternatively, the document may be received by a productivity application communicating with a publish and collection service/server via an application programming interface (API) of a publish and collections service/server. Other entry points are contemplated.

In addition to receiving a document to publish (201), a command to publish the document can be received (202) before the system takes steps to publish the document. The command may be explicit, for example, through a “publish” button or gesture, or implicit, for example, as a result of a finished process that was carried out by the system or through an indication that the user is “done”.

After the command to publish the document is received (202), the document can be stored in a storage of the system (203). In addition to the document, metadata is stored associated with the document (204). A representative image can also be stored for use in displaying the document.

With the storing of the document and associated metadata, the document can be published on a distribution network (205). The document can be published by being added to a distribution network such as described with respect to the publish and collection service(s) 100 of FIG. 1. The published document may then be discoverable.

The document may be associated with a document collection. In some cases the document may be published directly into a collection (either a newly created collection or an existing collection). A request can be received to add the published document to a collection (206). This request may be part of the process flow during the steps a user takes to publish a document (e.g., when the user adds the document to the distribution network). In some implementations, documents can be added to a collection by indicating the document URL, by selecting from existing published documents of the distribution network, by performing a drag and drop operation from documents both inside and outside the distribution network, by selecting to add to a collection when viewing a document, or by selecting to add to a collection while browsing or searching documents available on the distribution network, as some non-limiting examples.

In response to receiving a request to add a document to a collection (206), the system updates the metadata for the document to include a collection identifier for the user's collection (207). The document may be included in multiple collections and, for each collection, the metadata of the document includes the collection identifier (and information related to that collection and its display).

The document can then be displayed as the representative image (e.g., “thumbnail” or “tile”) when a document collection is listed or shared (208).

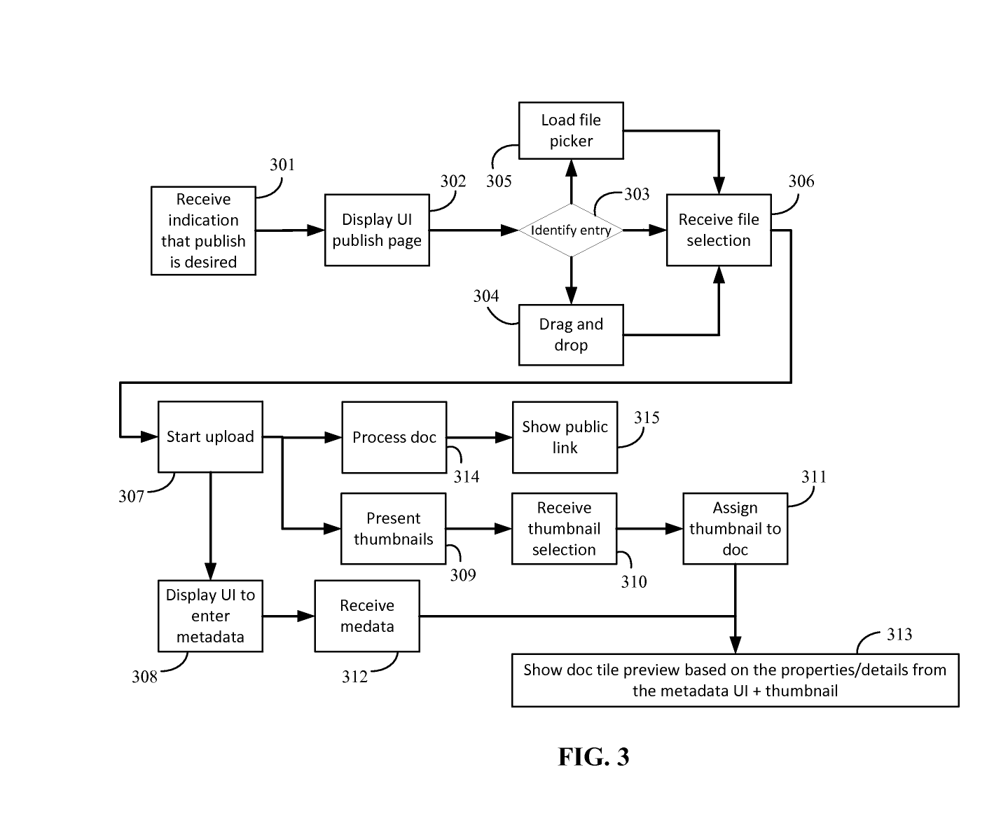

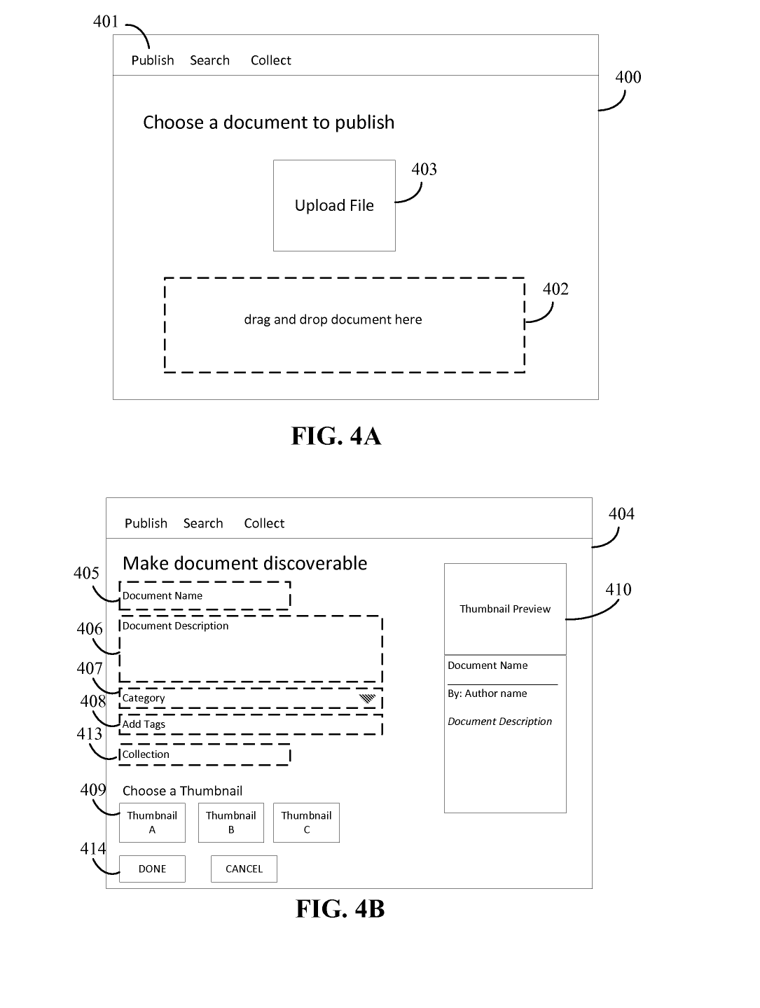

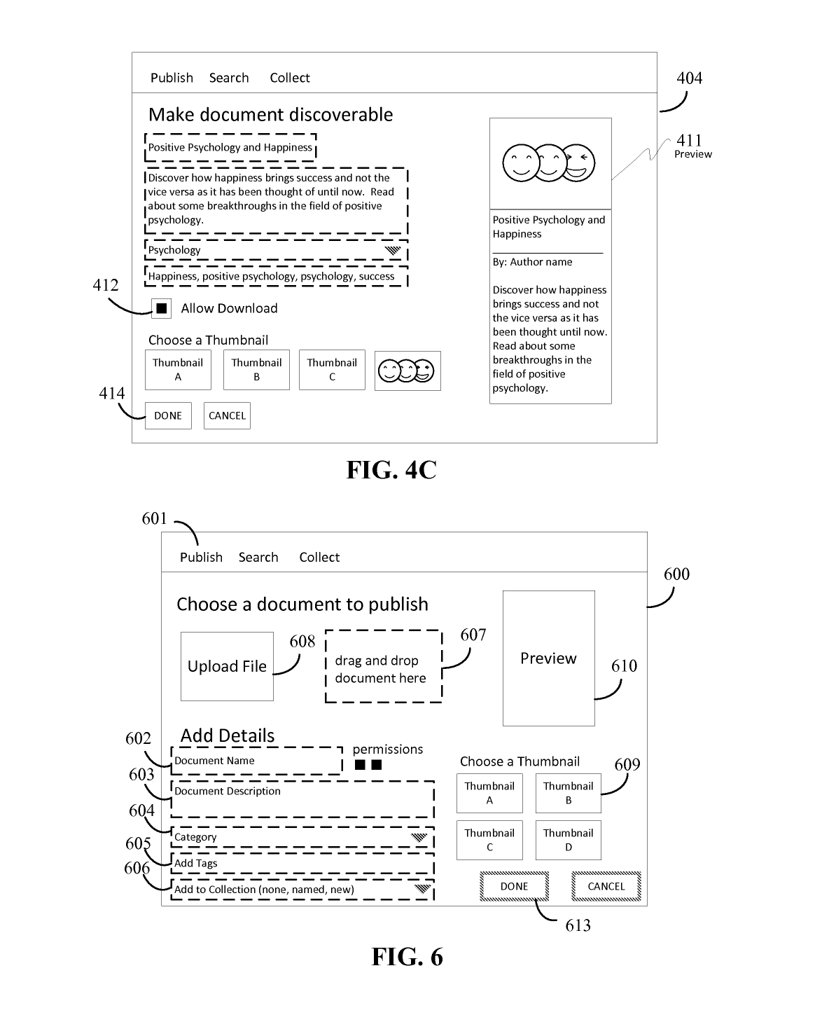

FIG. 3 illustrates an example publish process flow and FIGS. 4A-4D are views illustrating an example publish process flow. Referring to FIG. 3, in response to receiving an indication that publishing is desired (301), a user interface (UI) may be displayed for publishing a document (302). The UI can be a publish UI of a site page rendered in a browser of a user's device. An example site page is shown in FIG. 4A. Referring to FIG. 4A, a site page 400 for a publish and distribution system can include a publish UI 401, which facilitates the uploading of a document to publish. Two methods of uploading a document through the publish UI 401 are shown: a drag and drop region 402 and a button or user interface element for launching a “file picker” (upload file 403) A file picker is a program that enables exploration and selection of a file from one or more drives.

A user can access the service through their browser and publish a document via the site user interface 401. Thus, documents can be published from a site page such as shown in FIG. 4A. Of course, other entry points are contemplated.

The manner of uploading (e.g., drag and drop, file picker) can be identified (303). When a document is detected as being dragged into a designated region (e.g., region 402) of the user interface 401, the system can initiate a drag and drop upload operation (304). When the upload file 403 option is selected, a file picker may be loaded (305). Through either example method illustrated, the file selection can be received (306).

In response to receiving a file selection, the uploading of the file (307) may begin to copy the file from its source to the system's storage (e.g., the storage/documents database 105 associated with the service 100 as illustrated in FIG. 1). While the file is being uploaded (and even after file completes uploading), a user interface can be displayed to enable a user to enter metadata (308).

The metadata for a document stored by the system can include one or more of the following properties: properties that will help classification and ranking of the document; properties that can be used to attract usage in absence of other indicators that the system may use to promote a document; properties that facilitate the consumption of the document in a manner intended by author; and properties related to privacy.

Examples of metadata properties that may be populated for each document can include a system assigned identifier, a title, publisher, and a publish/upload date. Other metadata may be included that provide category and topic information for the document. The above examples of metadata can be helpful for classification (and even search when used as a tag).

In one implementation, the publish process can involve adding a title and a privacy setting to a document's metadata. In some cases, the document title is automatically populated from the document's file name and privacy setting is defaulted to public. Additional metadata may optionally be defined by an author (or publisher) user.

For search capabilities, a description and tags may be included. In some cases, the category and topic information can be input by a user. For example, an interface can be presented where the user can select the category to which the document content may belong. In other cases, the content in the document may be scanned and a category detected or determined automatically. In such cases, the category information may automatically be used as a tag or presented to the user for approval before being applied as metadata for the document.

An image can also be provided for the document. For example, a representative image in the form of a thumbnail, or “tile”, for the document may be presented (309) for the user to select or this representative image may be created (or otherwise obtained).

This image can be a generic thumbnail based on file type, a thumbnail selected from a list of available images associated with a particular category/topic, a selection of images from the content, or an image suggested by a search engine that is related to the topic area of the content in the document.

The representative image can be generated, for example, by extracting images from the document, if present, or by obtaining images related to the content (after determining subject matter of the content). In some cases, the representative images may be stock/default images. A smaller representation of a portion of the content may be used as one or more of the options a user may select. According to certain implementations, the thumbnails available for selection do not include a smaller representation of the first page (or other page) of a document. Instead, an image found in the document, an image available from a default selection based on the subject matter of the document (e.g., by analyzing the document, based on a selected category, and/or based on a tag input by the user), or an image obtained from a search of a variety of image sources (e.g., via a search engine such as BING or GOOGLE) using terms based on the subject matter of the document.

FIG. 4B illustrates an example interface for receiving user defined metadata. Referring to FIG. 4B, a metadata UI 404 can include input fields for document name 405, document description 406, category 407, tags 408, and thumbnail selection 409. In addition, a preview region 410 can also be provided to show the user a preview of a representative image (and information) for the document.

Returning to the process flow illustrated in FIG. 3, a thumbnail selection can be received (310) and the selected thumbnail assigned to the document (311). Metadata, including selection of a representative image (or thumbnail) may be received via the metadata UI (312). A preview document representation can be displayed, where the preview is based on the properties/details received from the metadata UI and the thumbnail selection (313).

FIG. 4C shows an example user input of metadata via the metadata UI 404. Referring to FIG. 4C, the document information is input to the UI 404 and a preview image 411 is displayed. A published document can include settings related to document interaction, for example, whether other users may download a local copy of the document. FIG. 4C illustrates a download permission setting 412 to indicate that downloading is permitted. Other publishing and interaction permissions may be included. Examples of publishing and interaction permissions include, but are not limited to, information related to copyright, geographical scope of syndication, permissions for downloads, comments, and other uses. Privacy permission can also be included, such as a privacy setting that enables a user to maintain a document as private within the publication system.

A user may also input collection information via the metadata UI 404. For example, a user may select to publish the document to a specific collection (either an existing collection or a new collection) via a collection input field 413.

As shown in FIG. 3, a document's content may also be processed (314), for example, for inappropriate content or harmful code. Once the processing is finished and a user has indicated that the document is ready for publishing (e.g., by selecting “done” 414), a public link may be presented to the user to facilitate sharing (315). Documents that have been published to the service can then be shared, for example, using a public URL or direct access to social media and other sites. A collection of documents can also be shared through similar methods.

A uniform resource locator (URL) for the collection can be generated so that a user may share a collection with others. Such a URL posted to a social media site or sent to another person via email can enable the recipient or viewer to click the link and be taken to a page presenting the collection. From the collection page, the user may click on any document to start consuming it via viewer apart from when author has specified a strict consumption order, in which case user can see all documents in the collection but only consume the first document in the collection.

Users can embed a collection in their blogs/website or download as a zip file/folder from the site (so long as the document includes permissions to allow downloading of the file).

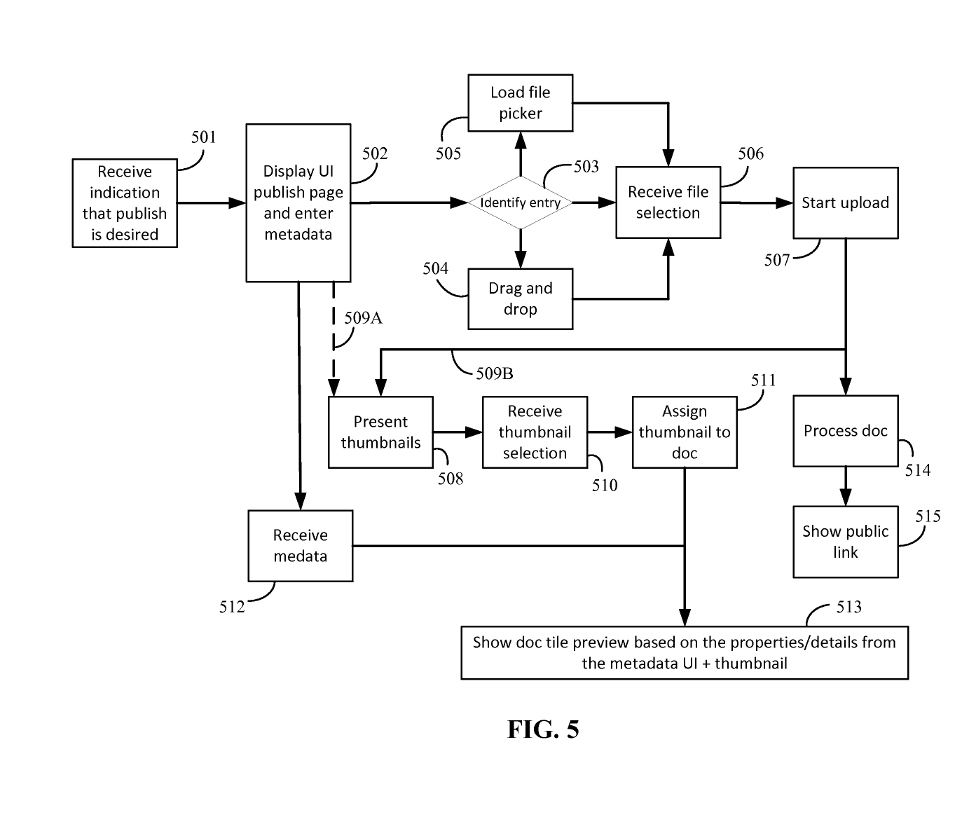

FIG. 5 illustrates a process flow in which metadata for a document that is being published can be entered before or during the uploading of a file to the service; and FIG. 6 is a view of an example interface. Referring to FIG. 5, in response to receiving an indication that publishing is desired (501), a UI may be displayed for publishing a document (502). The UI can be a publish UI of a site page rendered in a browser of a user's device. For this implementation, instead of separate interfaces for uploading and entering metadata, a site page 600 for a publish and distribution system as shown in FIG. 6 can include a publish UI 601, which facilitates both the uploading of a document to publish and entering metadata (such as document name 602, document description 603, category 604, tags 605, and even collection 606) regarding the document.

In some scenarios, a user may enter metadata for a document before uploading a document to be published. For example, metadata may be received before a particular document is copied to the service. In other scenarios, the metadata entry may be locked (e.g., unavailable for data entry) until a file is selected for uploading. In one such scenario, the section to add the details for the document may be shown but not available until the document upload has been completed. The section to add information for association with the document (e.g., the document name 602, document description 603, category 604, tags 605, and even collection 606) are optional to completing the publish process.

As with the process flow illustrated in FIG. 3, the manner of uploading (e.g., drag and drop 607, file picker upload file 608 of FIG. 6) can be identified (503). When a document is detected as being dragged into a designated region (e.g., region 607) of the user interface 601, the system can initiate a drag and drop upload operation (504). When the upload file 608 option is selected, a file picker may be loaded (505). Through either example method illustrated, the file selection can be received (506). In response to receiving a file selection, the uploading of the file (507) may begin to copy the file from its source to the system's storage (e.g., the storage/documents database 105 associated with the service 100 as illustrated in FIG. 1).

Representative images 609 can be presented to the user for selection (508) based on input to the publish UI 601 (509A) and/or based on the file being uploaded (509B). Once a thumbnail selection is received (510), the selected thumbnail can be assigned to the document (511). Metadata, including selection of a representative image (or thumbnail) may be received (512) via the publish UI 601 or a separate UI. A preview document representation 610 can optionally be displayed, where the preview is based on the properties/details and thumbnail selection received from the UI (513).

Again as described with respect to FIG. 3, a document's content may also be processed (514), for example, for inappropriate content or harmful code. Once the processing is finished and a user has indicated that the document is ready for publishing (e.g., by selecting “done” 613), a public link may be presented to the user to facilitate sharing (515).

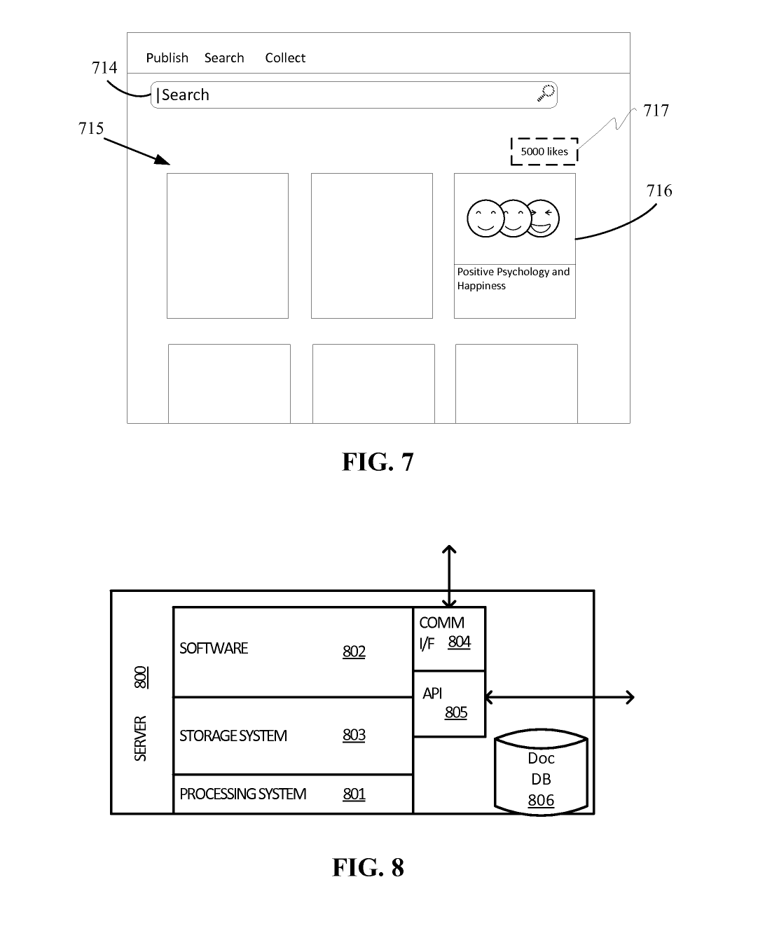

Once documents have been published, these documents can be discoverable by a search of the site such as illustrated in FIG. 7 (or even a general search via a search engine such as MICROSOFT BING and GOOGLE).

FIG. 7 illustrates an example search UI 714 presenting documents 715 (and/or collections of documents). As illustrated in FIG. 7, the published document 716 created as illustrated in FIG. 7 is available on the distribution network upon a search.

Social information can be included. Users with a link to the collection can view documents and properties associated with, and interact via, social features provided on a collection page to show appreciation, share with friends or tag for getting back to the collection later via “liking” (e.g., a feature available through FACEBOOK or TWITTER) or directly or “bookmarking” (e.g., a setting that lets a user return to a collection). For social scenarios, a collection may be “liked” and a number of likes and views may viewable; collections can be shared to social media sites such as FACEBOOK and TWITTER. For example, as shown in FIG. 7, an indication 717 of the number of likes can be provided.

User collections may be personal. For example, a user may create a collection for personal organization of ideas and content. The privacy setting can be useful in keeping personal collections private. For example, a private collection may function as a private staging area for a project or deliverable, where documents are collected for later review and analysis. A private collection can also help users to keep their interests private.

User collections may be public so as to allow other users to consume related documents within the user's single collection. For example, a user collection may be publically shared with other users. Collection management and interaction, as well as a look and layout of a collection, may be controlled by a user.

The collections, grouped for example by topics or areas, can enable a light level of file management of the publicly shared files on the distribution network. The collections may be user generated or system generated (for ease of search and display).

User generated collections include an online collection curation of documents where the user does not need to be the publisher of the document. Curation refers to the organization and presentation (or sharing) of content from various sources. Public sharing of curated collections is possible via the distribution network. The collections can be shared so that other users who are searching for a specific interest can view the user-generated collections via the distribution network. For example, a consumer (a user that uses or views the content) can search for collections on topics that interest them and take advantage of other user's work in collecting related information through site search, browsing, or following authors.

For collection interaction, a user may customize a collection's content for sequencing of consumption, interaction settings as well as look and feel of the collection.

Collections of productivity documents that are related to a theme that the user chooses can be presented. Implementations enable a user to easily tag documents by subject matter or theme and show the related documents in an organized way. Each document can include metadata associated therewith that includes title and privacy permissions that may automatically populate by the system upon receipt of the file. In addition, user-specified tags can be included with the metadata. The user-specified tag can be from the publisher/author as well as from other users that select to include the document in their collection.

One or more of the following features may be available to a user through the publish and collection service(s): creation of a new collection to organize or collect documents; properties (e.g., metadata or “tags”) can be added to the collection to make the collection discoverable via a site search; the look and feel of a collection page (e.g., a view of the collections) can be customized through selection of a cover image and layout (e.g., arrangement or ordering of documents) for the documents in the collection; collections may be private for personal consumption only; collections may be updated, modified, and deleted; collection properties such as descriptions and tags may be specified and updated by a user; and collections may be created at any time, for example, while a user is browsing other collections or documents and while a user is publishing a document.

These features are not meant to be limiting or exhaustive.

FIG. 8 shows a block diagram illustrating example details of a publish and collection server that may be used to implement publish and collection service(s) 100 of FIG. 1. The server 800 may include one or more computing devices. For example, the server 800 can include one or more blade server devices, standalone server devices, personal computers, routers, hubs, switches, bridges, firewall devices, intrusion detection devices, mainframe computers, network-attached storage devices, and other types of computing devices. The server hardware can be configured according to any suitable computer architectures such as a Symmetric Multi-Processing (SMP) architecture or a Non-Uniform Memory Access (NUMA) architecture.

The server 800 can include a processing system 801, which may include a processing device such as a central processing unit (CPU) or microprocessor and other circuitry that retrieves and executes software 802 from storage system 803. Processing system 801 may be implemented within a single processing device but may also be distributed across multiple processing devices or sub-systems that cooperate in executing program instructions.

Examples of processing system 801 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system 803 may comprise any computer readable storage media readable by processing system 801 and capable of storing software 802. Storage system 803 may include volatile and nonvolatile, removable and non-removable media implemented in any method or technology for storage of information, such as computer readable instructions, data structures, program modules, or other data.

Examples of storage media include random access memory, read only memory, magnetic disks, optical disks, CDs, DVDs, flash memory, magnetic cassettes, magnetic tape, magnetic disk storage or other magnetic storage devices, or any other suitable storage media. Certain implementations may involve either or both virtual memory and non-virtual memory. In no case is the storage media a propagated signal. In addition to storage media, in some implementations storage system 803 may also include communication media over which software 802 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 801.

Software 802 may be implemented in program instructions and among other functions may, when executed by server 800 in general or processing system 801 in particular, direct server 800 or processing system 801 to operate as described herein for documents collections distribution and publishing. Software 802 may include additional processes, programs, or components, such as operating system software or other application software. Software 802 may also comprise firmware or some other form of machine-readable processing instructions executable by processing system 801.

In general, software 802 may, when loaded into processing system 801 and executed, transform server 800 overall from a general-purpose computing system into a special-purpose computing system customized to facilitate documents collections distribution and publishing as described herein for each implementation. Indeed, encoding software 802 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage.

Server 800 may represent any computing system on which software 802 may be staged and from where software 802 may be distributed, transported, downloaded, or otherwise provided to yet another computing system for deployment and execution, or yet additional distribution.

In embodiments where the server 800 includes multiple computing devices, the server can include one or more communications networks that facilitate communication among the computing devices.

For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 804 may be included, providing communication connections and devices that allow for communication between server 800 and other computing systems (not shown) over a communication network or collection of networks (not shown) or the air. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

The server 800 also includes an API server 805 and database 806. In various embodiments, the API server 805 can be implemented in various ways. For example, the API server 805 can be implemented as application software, utility software, or another type of software executed by one or more processing units of computing devices in the server system 800. Furthermore, in some embodiments, the API server 805 can be implemented using one or more application-specific integrated circuits (ASICs).

The API server 805 can be used to expose functionality available by the distribution and publishing server(s) (e.g., server 800). The database 806 can store documents and associated metadata. The API server 805 may be a separate computing device from the server 800 or represent an API service of the server 800 that enables user devices or other servers to invoke methods in the API.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A method of facilitating document collections distribution and publishing, comprising:
receiving a first document to publish;
receiving a command to publish the first document;
storing the first document and first document metadata for association with the first document in a storage, wherein the first document metadata comprises title, author, privacy permission, and collection information;
publishing the first document and setting the privacy permission to public; and
associating the first document with at least one collection, wherein the collection information comprises each user collection identifier with which the first document is associated.

2. The method of claim 1, wherein the storage comprises a first storage for published content including the first document and a second storage for managed metadata associated with the published content.

3. The method of claim 1, further comprising:
receiving a selection of a representative image for representing the first document.

4. The method of claim 1, further comprising generating a representative image for association with the first document.

5. The method of claim 4, wherein the representative image is generated based on a subject matter of the first document.

6. The method of claim 5, wherein the subject matter of the first document is received as an input from a user.

7. The method of claim 5, wherein the subject matter of the first document is determined based on analysis of content of the first document.

8. The method of claim 1, wherein the first document is a word processing document file type, a presentation file type, or a spreadsheet file type.

9. The method of claim 8, wherein the first document remains a same file type after being published.

10. The method of claim 1, further comprising adding a new user collection identifier to the first document metadata in response to receiving a request to include the first document in a user's collection.

11. The method of claim 1, further comprising presenting the first document as part of each collection identified by the collection information.

12. The method of claim 1, wherein the first document metadata of author is automatically populated with a user identifier corresponding to a user from which the first document is received.

13. The method of claim 1, further comprising:
generating a URL for external access to a collection associated with the first document in the storage.

14. The method of claim 1, wherein the privacy permission is automatically set to public in response to receiving the command to publish the first document.

15. A method of facilitating document collections distribution and publishing, comprising:
receiving a first document to publish;
receiving a command to publish the first document;
storing the first document and first document metadata for association with the first document in a storage;
publishing the first document in association with a document collection, wherein the first document metadata comprises a user collection identifier for the document collection; and
displaying the first document as a representative image in the document collection.

16. The method of claim 15, wherein the first document metadata further comprises author information, the author information remaining associated with the first document regardless of a number of collections the first document may be later associated with.

17. The method of claim 15, wherein the representative image comprises an image representing a subject matter of the first document.

18. The method of claim 15, wherein a file format of the first document is not indicated by the representative image.

19. The method of claim 15, wherein the first document is a word processing document file type, a presentation file type, or a spreadsheet file type and is not converted to a markup language file type before publishing the first document in association with the document collection.

20. A system for facilitating document collections and distribution, the system comprising:
a file storage;
one or more computer readable storage media;
a publishing service application embodied in program instructions stored on the one or more computer readable storage media that, when executed by a computing system, direct the computing system to publish a document without converting the document to a markup language file type, the computing system being directed to perform a method comprising:
in response to receiving a command to publish a first document of a word processing, spreadsheet, or presentation file format, storing the first document and first metadata for association with the first document in the file storage; and
in response to receiving each request to include the first document in a collection, updating the first metadata to include each user collection identifier.
